(19) United States
(12) Patent Application Publication
(10) Pub. No.: US 2006/0211840 A1
(43) Pub. Date: Sep. 21, 2006

(54) Polyurea aerogels

(75) Inventor: Je Kyun Lee, Brookline, MA (US)

Correspondence Address: ASPEN AEROGELS INC.;IP DEPARTMENT, 30 FORBES ROAD, BLDG. B, NORTHBOROUGH, MA, 01532, US

(73) Assignee: Aspen Aerogels Inc., Northborough, MA (US)

(21) Appl. No.: 11/384,475

(22) Filed: Mar. 20, 2006

Related U.S. Application Data
(60) Provisional application No. 60/594,219, filed on Mar. 20, 2005.

(51) Int. Cl. C08G 18/32; B32B 27/40

(52) U.S. Cl. 528/68

(57) ABSTRACT

Polyurea aerogels as well as methods for preparing the same are disclosed. One method involves mixing a polyisocyanate with a polyamine in a solvent and supercritically drying the resultant gel. Polyoxyalkyleneamine are a preferred type of the polyamines. Other optional steps for the formation of polyurea aerogels include addition of a catalyst, additives, fiber reinforcement, and aging.

### CROSS REFERENCE TO RELTED APPLICATIONS

This application claims benefit of priority from U.S. Provisional Patent Application 60/594,219 filed on Mar. 20, 2005 which is hereby incorporated by reference in its entirety as if fully set forth.

### STATEMENT REGARDING FEDERALLY SPONSORED RESEARCH OR DEVELOPMENT

This invention was partially made with Government support under Contract NNJ04JA22C awarded by the National Aeronautics and Space Administration (NASA.) The Government may have certain rights in parts of this invention.

### FIELD OF THE INVENTION

This invention pertains to polyurea aerogel monoliths and composites, and to methods for preparing the same.

### SUMMARY OF THE INVENTION

The present invention involves polyurea aerogel monoliths and composites. One method for preparation thereof comprises the steps of: mixing a polyisocyanate with a polyoxyalkyleneamine in a solvent, thereby forming a mixture; allowing the mixture to form a gel; and supercritically drying the gel. Optionally a catalyst, exemplified by tertiary amines, is added to the mixture. Also optionally, an additive such as an opacifier, chopped fibers, particulates is added to the mixture. Further optional, is a step comprising of introducing the mixture into a fibrous structure thereby forming a composite. The fibrous structure can comprise felt, mat, batting or a combination thereof. Yet another optional component of the method involves aging the gel. The polyoxyalkyleneamine may be characterized as comprising polyoxypropylenediamines, polyoxypropylenetriamines or both and preferably having a molecular weight between about 500 and about 5000. The polyisocyanate may be selected from the group consisting essentially of: aliphatic diisocyanates, cycloaliphatic diisocyanates, araliphatic diisocyanates, heterocyclic diisocyanates, aromatic diisocyanates diisocyanates, 1,6-hexamethylene diisocyanate, isophorone diisocyanate, 1,4-cyclohexane-diisocyanate, 1-methyl-2,4-cyclohexane diisocyanate, 1-methyl-2,6-cyclohexane diisocyanate, 4,4′-dicyclohexylmethane diisocyanate, 2,4′-dicyclohexylmethane diisocyanate, 2,2′-dicyclohexylmethane diisocyanate, toluene 2,4-diisocyanate (TDI), mixtures of toluene 2,4-diisocyanate and toluene 2,6-diisocyanate, 4,4′-diphenylmethane diisocyanate (MDI), 2,4′-diphenylmethane diisocyanate, 2,2′-diphenylmethane diisocyanate, mixtures of 2,4′-diphenylmethane diisocyanate and 4,4′-diphenylmethane diisocyanate, urethane-modified liquid 4,4′-diphenylmethane diisocyanates, 2,4′-di-phenylmethane diisocyanates, 4,4′-diisocyanato-diphenylethane-(1,2), 1,5-naphthylene diisocyanate, triphenylmethane 4,4′,4″-triisocyanate, polymethylene polyphenylene isocyanates (polymeric MDI), any isomeric form of these compounds and any mixtures of the aforementioned. Preferably the ratio of the polyoxyalkyleneamine to polyisocyanate is between about 0.01:1 and about 1:1. Even more preferably, the ratio of the polyoxyalkyleneamine to polyisocyanate is between about 0.05:1 and about 0.6:1. The polyurea aerogels and aerogel composite analogues can exhibit thermal conductivities of the less than about 20 mW/mK. Furthermore, their densities are typically between about 0.01 g/cm³ and about 0.3 g/cm³.

### DESCRIPTION

Polyurea in general describes polymers comprising a plurality of urea groups (—NH—CO—NH—) in a molecular chain. The most common method of preparing a polyurea involves condensation reactions between compounds containing isocyanate functional groups (—NCO) and those with amine (—NH₂) functional groups. Polyisocyantes as used herein denote compounds comprising two or more isocyanate functional groups. Similarly, polyamines (and polyamine hardeners) denote compounds comprising two or more amine functional groups. The structure of polyurea can be complex and diverse, containing “hard” and “soft” segments that contribute to the balance between rigid and less fragile properties. In one view the polyamine component is regarded as the “soft segment” since the polyisocyantes often contribute to forming a more stiff material. Thus, in order to obtain a less fragile material, the polyurea polymers may be designed with either a larger number of soft segments of polyamines, or contain longer (higher molecular weight) polyamine segments. Either approach leads to a less cross-linked, and thus less rigid material.

Uniform gel formation and the ability to withstand deformation due to capillary forces during supercritical drying are some requirements for successful preparation of the polyurea aerogel products. The lower reactivity of the polymeric hardeners used for imparting less fragile behavior can be a serious problem in aerogel processing, because aerogel products are generally prepared from very dilute solutions (low solid content). No gelation, very slow gelation, or significant deformation during supercritical drying is frequently observed from these less crosslinkable and less fragile systems. On the other hand, if more polyamine hardeners with relatively small molecular weight are used, a uniform gel is not observed where gel particulates are formed during mixing or the subsequent aging process via fast local polymerization and the phase separation.

The polyurea aerogels of the present invention can be used for thermal and acoustic insulation, radiation shielding, and vibrational damping applications in a variety of industries including, military, oil & gas, petrochemicals, and sports. Such materials are particularly relevant to applications requiring both flexibility and maximum thermal insulation performance.

One embodiment of the present invention involves mixing at least one polyisocyanate with at least one polyamine hardener in a solvent and allowing the mixture to gel. Subsequent drying of said gel results in a polyurea aerogel.

The amine hardeners may be selected from polyoxyalkyleneamines, amine based polyols, or the mixture of thereof. Suitable polyamine hardners include but are not limited to: polyoxyalkyleneamines such as polyoxyethylene-propylenemonoamines, polyoxypropylenediamines, and polyoxypropylenetriamines. The average molecular weight of the polyoxyalkyleneamines is preferably larger than 50, more preferably larger than 150. The preferred amine hydrogen equivalent weight (AHEW) is larger than 50. Examples of polyoxyalkyleneamines that are commercially available, include but are not limited to: Jeffamine® D-230, Jeffamine® T-403, Jeffamine® D-400, Jeffamine M-2005 (XTJ-507), Jeffamine® D-2000, Jeffamine® D-4000 (XTJ-510), Jeffamine® T-3000 (XTJ-509), and Jeffamine® T-5000 (all available from Huntsman Corp.).

polyisocyanate suitable for use include aliphatic, cycloaliphatic, araliphatic, heterocyclic and aromatic diisocyanates such as those which are described in U.S. Pat. No. 6,150,489 and “Justus Liebigs Annalen der Chemie 562”, pages 75-136 both hereby incorporated by reference. Preferred polyisocyanates include but are not limited to: aliphatic diisocyanates such as 1,6-hexamethylene diisocyanate, cycloaliphatic diisocyanates such as isophorone diisocyanate, 1,4-cyclohexane-diisocyanate, 1-methyl-2,4-cyclohexane diisocyanate, 1-methyl-2,6-cyclohexane diisocyanate and corresponding mixtures of isomers; 4,4′-dicyclohexylmethane diisocyanate, 2,4′-dicyclohexylmethane diisocyanate, 2,2′-dicyclohexylmethane diisocyanate and corresponding mixtures of isomers, and aromatic diisocyanates such as toluene 2,4-diisocyanate (TDI), mixtures of toluene 2,4-diisocyanate and toluene 2,6-diisocyanate, 4,4′-diphenylmethane diisocyanate (MDI), 2,4′-diphenylmethane diisocyanate and 2,2′-diphenylmethane diisocyanate; mixtures of 2,4′-diphenylmethane diisocyanate and 4,4′-diphenylmethane diisocyanate, urethane-modified liquid 4,4′-diphenylmethane diisocyanates and 2,4′-di-phenylmethane diisocyanates, 4,4′-diisocyanato-diphenylethane-(1,2) and 1,5-naphthylene diisocyanate, and isocyanate such as triphenylmethane 4,4′,4″-triisocyanate or polymethylene polyphenylene isocyanates (polymeric MDI) having an isocyanate functionality of greater than 2 and the so-called MDI variants (MDI modified by the introduction of urethane, allophanate, urea, biuret, carbodiimide, uretonimine or isocyanurate residues). Of particular importance are aromatic isocyanate resins such as TDI and the corresponding isomeric mixtures, MDI and the corresponding isomeric mixtures, and polymeric MDI. These isocyanate resins are commercially available from many companies such as Bayer, Dow, BASF, Huntsman, Imperial, Lyondell, Shell and Degussa.

Suitable solvents should be non-reactive towards any of the starting materials for preparation of a gel, or the resultant gel or composite material on the whole. Essentially, the solvent should act as a solvating agent for the starting materials, but act as a non-solvent towards the formed gel. Suitable solvents for use in the method according to the present invention include hydrocarbons, dialkyl ethers, cyclic ethers, ketones, alkyl alkanoates, aliphatic and cycloaliphatic hydrofluorocarbons, hydrochlorocarbons, hydrochlorofluorocarbons, chlorofluorocarbons, halogenated aromatics and fluorine-containing ethers. Mixtures of such compounds also can be used. Other suitable solvents include aliphatic or cyclic hydrocarbons such as ethane, propane, n-butane, isobutane, n-pentane, isopentane, cyclopentane, neopentane, hexane, cyclohexane, benzene, xylene, and toluene. Suitable dialkyl ethers include compounds having from 2 to 6 carbon atoms. Examples of ether solvents include dimethyl ether, methyl ethyl ether, diethyl ether, methyl propyl ether, methyl isopropyl ether, ethyl propyl ether, ethyl isopropyl ether, dipropyl ether, propyl isopropyl ether, diisopropyl ether, methyl butyl ether, methyl isobutyl ether, methyl t-butyl ether, ethyl butyl ether, ethyl isobutyl ether and ethyl t-butyl ether. Suitable cyclic ethers include tetrahydrofuran. Examples of dialkyl ketones to be used as solvents include acetone, cyclohexanone, methyl t-butyl ketone and methyl ethyl ketone. Suitable alkyl alkanoates which may be used as solvent include methyl formate, methyl acetate, ethyl formate, butylacetate and ethyl acetate. Suitable hydrofluorocarbons which may be used as solvent include lower hydrofluoroalkanes, for example difluoromethane, 1,2-difluoroethane, 1,1,1,4,4,4-hexafluorobutane, pentafluoroethane, 1,1,1,2-tetrafluoroethane, 1,1,2,2-tetrafluoroethane, pentafluorobutane and its isomers, tetrafluoropropane and its isomers, and pentafluoropropane and its isomers. Substantially fluorinated or perfluorinated (cyclo)alkanes having 2 to 10 carbon atoms can also be used. Suitable hydrochlorofluorocarbons which may be used as solvent include chlorodifluoromethane, 1,1-dichloro-2,2,2-trifluoroethane, 1,1-dichloro-1-fluoroethane, 1-chloro-1,1-difluoroethane, 1-chloro-2-fluoroethane and 1,1,1,2-tetrafluoro-2-chloroethane. Suitable chlorofluorocarbons which may be used as solvent include trichlorofluoromethane, dichlorodifluoromethane, trichlorotrifluoroethane and tetrafluorodichloroethane. Suitable hydrochlorocarbons which may be used as solvents include 1- and 2-chloropropane and dichloromethane. Suitable halogenated aromatics include monochlorobenzene and dichlorobenzene. Suitable fluorine-containing ethers which may be used as solvents include bis-(trifluoromethyl)ether, trifluoromethyl difluoromethyl ether, methyl fluoromethyl ether, methyl trifluoromethyl ether, bis-(difluoromethyl)ether, fluoromethyl difluoromethyl ether, methyl difluoromethyl ether, bis-(fluoromethyl)ether, 2,2,2-trifluoroethyl difluoromethyl ether, pentafluoroethyl trifluoromethyl ether, pentafluoroethyl difluoromethyl ether, 1,1,2,2-tetrafluoroethyl difluoromethyl ether, 1,2,2,2-tetrafluoroethyl fluoromethyl ether, 1,2,2-trifluoroethyl difluoromethyl ether, 1,1-difluoroethyl methyl ether, 1,1,1,3,3,3-hexafluoroprop-2-yl fluoromethyl ether.

The preferred solvents include toluene, methyl ethyl ketone, acetone, tetrahydrofuran, dichloromethane, monochlorobenzene, trichlorofluoromethane, chlorodifluoromethane, 1,1,1-trifluoro-2-fluoroethane, 1,1-dichloro-1-fluoroethane. The most preferred solvents are acetone, methyl ethyl ketone, tetrahydrofuran, and toluene.

At least one polyisocyanate resin is used in amounts ranging from about 0.5 to about 40% by weight depending on the theoretical target density, preferably from about 1 to about 35% by weight, and more preferably from about 2 to about 30% by weight based on the weight of total reaction mixture.

The polyamine hardeners are used at specific ratios between functional groups in the polyoxyalkyleneamines hardener (—NH₂) and functional groups in the polyisocyanate resin (NCO). This specific ratio of functional groups between polyamine hardener and the polyisocyanate is very relevant in determining thermal and physical properties of the final polyurea aerogels. If polyamine hardener is used more than the preferred amount, either a very hard xerogel results due to phase separation or no gel occurs. The preferred ratio between functional groups in the polyamine hardener (NH₂) and functional groups in the polyisocyanate resin (NCO) is between about 0.01:1 and about 1:1, and more preferably between about 0.05:1 and about 0.6:1.

The solvent amount for use depends on the desired density and additives used (such as opacifiers and reinforcement material). The nature and amount of solvent that can be used may be based on the theoretical (or target) density while considering that the final density is generally higher than the theoretical density typically due to shrinkages occurring during aging and/or supercritical drying steps. The solvent amount for use in the present invention is preferably in such an amount that the target density of aerogel ranges from about 0.01 g/cm³ to about 0.5 g/cm³, and more preferably from about 0.03 g/cm³ to about 0.4 g/cm³.

Another embodiment of the present invention involves mixing at least one polyisocyanate, at least one polyamine hardener and a catalyst in a solvent and allowing the mixture to gel. Subsequent drying of said gel results in a polyurea aerogel.

The preferable catalysts for use in the present invention include those able to promote polyurea which include but are not limited to: certain aliphatic and aromatic primary, secondary and tertiary amines; long chain alkylamide compounds, such as ethylamine, 1-benzofuran-2-amine, 4-quinolylamine, [1,1′-binaphthalene-3,3′,4,4′-tetrayl]tetraamine, p-aminobenzoic acid, dimethylamine, N-methylethanamine, diethylamine, N-methylisopropylamine, N-isopropylcyclobutanamine, N,2-dimethyl-3-pentanamine, N,N-dimethylethanamine, N-methyldiethanamine, N-ethyl-N-methyl-3-hexanamine, commercially available didecylmethylamine (DAMA-1010 amine, tertiary amine of 98.9 wt %, available from Albemarl Corporation); and organometallic compounds, especially tin compounds such as stannous octoate and dibutyltin dilaurate, alkali metal salts, especially, commercially available from Atofina Chemicals, Inc., stannous bis(2-Ethylhexoate) (FASCAT 2003), dibutyltin diacetate (FASCAT 4200), and dibutyltin dilaurate (FASCAT 4202). Other catalysts include any isocyanate trimerisation catalyst such as quaternary ammonium hydroxides, alkali metal and alkaline earth metal hydroxides, alkoxides and carboxylates, for example potassium acetate and potassium 2-ethylhexoate, non-basic metal carboxylates, for example lead octoate, and symmetrical triazine derivatives. Commercially available preferred trimerisation catalysts for use in the present method are Tris(dimethylaminopropyl)hexahydrotriazin (Polycat 41) and N-hydroxypropyltrimethyl ammonium-2-ethylhexanoate (DABCO TMR) 2-hydroxypropyl trimethylammonium formate (DABCO TMR-2), and N-hydroxy-alkyl quarternary ammonium carboxylate (DABCO TMR-4) available from Air Products. Other preferable catalysts are triethylamine, triethanolamine diphenylamine, didecylmethylamine (DAMA-1010), stannous bis (2-Ethylhexoate) (FASCAT 2003), dibutyltin diacetate (FASCAT 4202), tris(dimethylaminopropyl)hexahydrotriazin (Polycat 41), and N-hydroxypropyltrimethyl ammonium-2-ethylhexanoate (DABCO TMR).

The amount of catalyst amount for use depends on the desired gel time, the amount of polyisocyanate resin and polyamine hardener, reaction temperature, solvent type, and amount of additives incorporated (if any). The catalyst amount is preferably used in such an amount that the ratio between the total weight of catalyst and polyisocyanate and polyamine hardeners is between about 0:1 (0 wt % catalyst) and about 0.2:1 (20 wt % catalyst), preferably between about 0.001:1 (0.1 wt % catalyst) and about 0.1:1 (10 wt % catalyst).

Another embodiment involves mixing at least one polyisocyanate, at least one polyamine hardener, a catalyst (optional) and at least one additive in a solvent and allowing the mixture to gel. Subsequent drying of said gel results in a polyurea aerogel with said additives incorporated therein. Examples of additives include, opacifiers, reinforcement materials (chopped fibers, particulates, etc.) and various others.

In order to further improve the thermal and mechanical properties, the structural integrity, and the handling of the aerogel monoliths, IR opacifiers and/or reinforcement materials such as fibers and particulates can be incorporated in the sol-gel process. The additive amount is preferably between 0.05 and 50% by weight based on the weight of polyisocyanate resin and polyamine hardener. Examples of suitable IR opacifiers and reinforcement materials include carbon black (added as dispersion or dispersed from powder form), carbon fiber, boron fiber, ceramic fiber, rayon fiber, nylon fiber, olefin fiber, alumina fiber, asbestos fiber, zirconia fiber. Particulates of alumina, clay, mica, silicas, calcium carbonate, titanium dioxide, talc, zinc oxide, barium sulfates, wood, and polystyrene may also serve as additives.

Another embodiment, involves mixing at least one polyisocyanate, at least one polyamine hardener, a catalyst (optional) and at least one additive (optional) in a solvent. The mixture is then poured over a fibrous structure and allowed to gel. Subsequent drying of said gel results in a fiber-reinforced polyurea aerogel composite.

The fibrous structure may comprise a felt, mat, batting, or a combination thereof. A non-limiting mode of practice entails placing the fibrous structure in a mold into which the mixture is poured and allowed to gel. The mixture may be entirely or partially infused into said fibrous structure and allowed to gel. Preferably a batting in lofty form is used as the fibrous structure; Battings may be polyester-based battings such as polyolefin terephthalates, poly(ethylene) naphthalate, polycarbonates and Rayon®, Nylon®, cotton-based lycra (manufactured by DuPont), carbon-based fibers such as graphite, carbon fiber precursors such as polyacrylonitrile (PAN), oxidized PAN, uncarbonized heat-treated PAN (manufactured by SGL carbon); fiberglass based material like S-glass, 901 glass, 902 glass, 475 glass, E-glass; silica-based fibers like quartz, Quartzel® (manufactured by Saint-Gobain), Q-felt® (manufactured by Johns Manville), Saffil® (manufactured by Saffil), Durablanket® (manufactured by Unifrax) and other silica fibers; polyaramid fibers like Kevlar®, Nomex®, Sontera® (all manufactured by DuPont) Conex® (manufactured by Teijin); polyolefins like Tyvek® (manufactured by DuPont), Dyneema® (manufactured by DSM), Spectra® (manufactured by Honeywell); other polypropylene fibers like Typar® and Xavan® (both manufactured by DuPont); fluoropolymers such as PTFE with trade names such as Teflon® (manufactured by DuPont), Goretex® (manufactured by GORE); silicon carbide fibers like Nicalon® (manufactured by COI Ceramics) and ceramic fibers like Nextel® (manufactured by 3M.) Other battings may be based on acrylic polymers, fibers of wool, silk, hemp, leather, suede, PBO-Zylon® fibers (manufactured by Tyobo), liquid crystal material like Vectan® (manufactured by Hoechst), Cambrelle® fiber (manufactured by DuPont), polyurethanes, polyamides, wood fibers, boron, aluminum, iron, stainless steel fibers and thermoplastics like PEEK, PES, PEI, PEK, PPS.

In presence of oxygen and high temperatures organic aerogels may undergo oxidation. Antioxidants can be incorporated into the aerogel to counter this effect. Antioxidants can be incorporated in the sol-gel process, preferably in an amount of between 0.1 and 20% by weight based on the weight of polyisocyanate resin and hardener. Examples of suitable antioxidant materials include phenol-based compounds or phosphorus-based compounds. The commonly known general-purpose phenol-based compound antioxidants, especially commercially available material such as Irganox®259, Irganox® 1010, or Irganox® 1076 (manufactured by Ciba Specialty Chemicals, Inc) can be used herein. The phosphorus-based compounds are exemplified by the material commercially available under the trademark Ultranox® 626, Ultranox® 641, or Ultranox® 668 (manufactured by GE Specialty Chemicals). They may be used alone or in combinations of two or more.

Another embodiment involves mixing at least one polyisocyanate, at least one polyamine hardener, a catalyst (optional) and at least one additive (optional) in a solvent. The mixture is then allowed to gel and subjected to aging. Subsequent drying of said gel results in a strengthened polyurea aerogel.

A general mode of practicing embodiments of the present invention is as follows: A mixture is prepared by mixing at least one polyisocyanate and at least one polyamine hardener in a solvent. Optionally, a catalyst is added to the mixture. Alternately, the polyisocyanate resin is dissolved in a portion of the solvent, and the polyamine hardener separate portion of the solvent before combining the two. Optionally a solution of the catalyst in a residual amount of solvent is added to the mixture. Mixing can be done at room temperature or at a somewhat higher temperature that is below the boiling temperature of solvent(s) used. The solids content of the reaction mixture is preferably between 1 and 45% by weight, and more preferably between 3 and 40% by weight. Thereafter, the mixture is left standing for a certain period of time to form a gel. This time period typically varies from 30 seconds to several days, even weeks and months, depending on the types of ingredients, the ratio between functional groups in the polyisocyante and in the polyamine hardener, catalyst content, and the target density. The gelation time for the is preferably between 30 second and 6 hours. The more preferable time to form a polymeric gel ranges from 1 minute to 2 hours. Temperatures in the range of from about −10° C. to about 80° C., preferably 110° C. to 60° C. may be employed in gelation.

In order to form a more uniform gel, it is recommended to stabilize the gels at room temperature for a short period so that handling is easier during subsequent processing. This step is important in processing weak gels prepared with lower target density. The typical period for this process varies from 5 minutes to 20 hours at room temperature, more typically between 20 minutes and 2 hours.

Although the mixture usually gels within a few hours or as quickly as seconds, it has been found advantageous to age (post-cure) the wet gels at elevated temperatures, for a certain period of time so as to obtain a stronger gel that can be easily handled during subsequent processing. Aging at a higher temperature reduces the time needed to obtain a stronger gel. Therefore, the wet gels can be aged at elevated temperatures for a certain period of time until the weak polymeric wet gel becomes strengthened. This aging process is required in processing weak gels prepared with lower target density. The preferable aging time period for use in the present invention varies from 1 hour to several days, more preferably, ranges from 2 hours to 48 hrs. Aging temperatures ranges from 10° C. to 100° C., preferably from 20° C. to 80° C.

Preferred aging solvents for aging are methanol, ethanol, propanol, toluene, methyl ethyl ketone, acetone, 4-methyl-2-pentanone, tetrahydrofuran, dichloromethane, monochlorobenzene, trichlorofluoromethane, chlorodifluoromethane, 1,1,1-trifluoro-2-fluoroethane, 1,1-dichloro-1-fluoroethane. Preferably the aging solvent is added in an amount such that the solvent forms a layer over the wet gel surface. Optionally, the aging solution can contain hydrophobic agents to improve the hydrophobicity and catalysts to promote the post curing. Also optionally, the aged wet gel can be washed with fresh solvent after aging process and before supercritical drying.

In a subsequent step, the polyurea aerogel is obtained from the wet gel following a supercritical drying step. The preferable supercritical drying for the present invention includes placing the solvent-filled gel in a temperature-controlled pressure vessel and bringing the vessel to a pressure above the critical pressure of CO₂ by filling with gaseous CO₂ or liquid CO₂. In another embodiment, before the supercritical drying step, the solvent in the wet gel can be exchanged with liquid carbon dioxide. Modifiers such as surfactants and triglycerides can be added to the carbon dioxide to make the gels more suitable for supercritical drying. At that point the vessel is then heated above the critical temperature of the CO₂. After a few hours the pressure is slowly released from the vessel while keeping a constant temperature. After the vessel cools down and is at atmospheric pressure, dried polyurea aerogel is removed from the vessel. The polyurea aerogels and aerogel composites thus produced exhibit low thermal conductivity, possess excellent mechanical properties and very low densities.

In one embodiment, the target, or theoretical, densities of the polyurea aerogels are in the range between about 0.01 g/cm³ and about 0.5 g/cm³, or between about 0.03 g/cm³ and about 0.4 g/cm³.

In another embodiment polyurea aerogels generally exhibit pore sizes in the range between about 1 to about 100 nm, as obtained by the Brunauer-Emmet-Teller (BET) nitrogen adsorption method. The average pore diameter is calculated as 4V/A where “V” represents cumulative pore volume per gram of material and “A” the specific surface area. Furthermore the BET surface areas of the polyurea aerogels are generally in the range of about 0.1 to about 500 m²/g.

The thermal conductivity coefficient of the polyurea aerogel monolith and composite depends in part on the final aerogel densities. At room temperature and atmospheric pressure, the polyurea aerogels prepared according to one embodiment of the present invention generally have thermal conductivity coefficients below about 50 mW/m K. The thermal conductivity coefficients of the polyurea aerogels at reduced pressures (i.e. below 0.001 torr) are generally lower than about 10 mW/m K.

The potential applications for the present polyurea aerogel monoliths and composite include, but are not limited to, uses for thermal and acoustic insulation, radiation shielding and vibrational-damping in aerospace, military. Commercial applications that require exceptional flexibility and durability simultaneously with maximum thermal insulation performance also benefit from this technology. Examples include space suits, gloves, footwear, helmets, systems for warming, storing, and/or transporting food and medicine, sleeping bags and pads, military and recreational cloth and tents. Because of their excellent thermal insulation performance, highly porous structure, and large surface area, more applications can be envisioned such as: catalyst supports, selectively permeable membranes, sensors, packing materials, aircraft insulation, cryogenic tank liners, liquefied gas transport, etc. Also due to their good rubbery behavior, polyurea aerogel of the present invention can be used or recycled for use as impact modifiers and/or filler materials for conventional plastics.

The following examples are provided to better illustrate the embodiments of the present invention and do not serve as limitation the scope or spirit of the invention in any manner.

### Materials

Mondur ML: a mixture of 4,4′- and 2,4′-Diphenylmethane Diisocyanate (MDI) available from Bayer Company, Inc., having isocyanate equivalent weight of 125; NCO content by weight of 33.6%, functionality of 2.

Mondur TD-80: a 80/20 mixture of 2,4- and 2,6-Toluene Diisocyanate (TDI) available from Bayer Company, Inc., having isocyanate equivalent weight of 87.5; NCO content by weight of 48%, functionality of 2.

PAPI 94: a polymeric MDI of polymethylene polyphenylisocyanate containing MDI available from DOW Chemical Company, Inc., having isocyanate equivalent weight of 131.5; NCO content by weight of 32%, functionality of 2.3, and the number average molecular weight of about 290.

Jeffamine® T-3000: polyoxypropylenediamine (Trifuntional primary amine) available from Huntsman Corporation, having an amine hydrogen equivalent weight of about 500, total amine of 0.94 meq/g, and the average molecular weight of about 3,000.

Jeffamine® D-400: polyoxypropylenediamine (Difuntional primary amine) available from Huntsman Corporation, having an amine hydrogen equivalent weight of about 115, total amine of 4.4 meq/g, and the average molecular weight of about 400.

Triethylamine: a tertiary amine catalyst available from Aldrich.

### EXAMPLE 1

First, 4.43 g of Mondur ML MDI were weighed into a polypropylene container with a screw cap. Subsequently 90.86 g of acetone were added and the mixture was stirred to obtain a homogeneous solution. Next, 4.06 g of Jeffamine® T-3000 polyamine hardener were added to this mixture and blended until a homogeneous solution was obtained. To this solution 0.65 g of TEA catalyst was incorporated by using a microliter syringe. After stirring thoroughly to ensure a homogeneous dispersion of the catalyst through the mixture for 1 min, the time to gelation was recorded. Some of the sol was poured into a plastic container containing quartz fiber batting in order to prepare both monolith and composite samples. Containers for the monolith and composite were closed and sealed to prevent evaporation and the contents were maintained in a quiescent condition to form a polymeric gel. After waiting 30 min to ensure the uniform gelation of the mixture, acetone was added into the container in an amount to cover the gel surface. In this way, collapse of the pore structure due to evaporation of solvent out of the gel was avoided. The wet gels were aged for 20 hrs in an oven preset at 50° C.

Once the aging process was completed and samples were cooled, the wet gel was loaded into a pressure vessel having a volume of 60 L. After closure of the vessel, liquid CO₂ at about 10° C. was introduced through a valve at the top of the vessel, and pressure was built up to 1500 psig over 10 minutes. Then the acetone was exchanged for liquid carbon dioxide and the mixture of CO₂ and acetone was withdrawn through a pressure relief system that maintains the pressure inside the vessel at 1500 psig; the mixture CO₂ and acetone was decompressed and reheated in separators where gaseous CO₂ and acetone were withdrawn, CO₂ being recycled through liquefaction and pumping, as commonly practiced in supercritical fluid extraction equipment. When little acetone remained, the pressure vessel was heated up 50° C. for 50 minutes until the supercritical condition of the CO₂ was reached. After supercritically drying the sample for 1 hr, the pressure was slowly released from the vessel for a period of 90 min or until atmospheric conditions were reached. The dried aerogel was removed from the vessel.

The resulting polyurea aerogel was opaque and had a white color due to the color of the Mondur ML polyisocyanate and Jeffamine® T-3000 polyamine resins. Density of the obtained gel was 0.1595 g/cm³, which means the shrinkage factor (final dried density/target density) was about 1.60. The pore structure of the obtained gel was characterized by using BET measurements. Results on the first polyurea aerogel revealed a surface area of 10 m²/g. The thermal conductivity coefficient at a single temperature was measured in air at atmospheric pressure and showed 19.5 mW/m K. A quartz fiber-reinforced polyurea aerogel composite of this example showed a density of 0.1528 g/cm³ and a thermal conductivity coefficient of 19.9 mW/m K.

### EXAMPLE 2

First, 4.37 g of PAPI 94 polymeric MDI was weighed into a polypropylene container with a screw cap. Subsequently 91.04 g of acetone were added and the mixture was stirred to obtain a homogeneous solution. Next, 3.94 g of Jeffamine® T-3000 polyamine hardener were added and blended until a homogeneous solution was obtained. The same ratio between functional groups of hardener and of polyisocyanate as used in Example 1 was used. To this solution 0.65 g of TEA catalyst was incorporated by using a microliter syringe. After blending the solution for 1 min, the same method as described in Example 1 was used for the gelation and aging steps.

Once the aging process was completed, the wet gel was loaded into a pressure vessel and was subsequently supercritically dried using the same method as described in Example 1. The resulting polyurea aerogels was slightly more flexible than the aerogels of Example 1 prepared with the same ratio between functional groups of polyisocyanate and polyamine hardener. The obtained polyurea aerogel was opaque, had a slightly yellow color due to the color of the PAPI 94 polyisocyanate resins, and showed the following properties: density of 0.1356 g/cm³ (shrinkage factor of about 1.36), surface area of 70 m²/g, thermal conductivity coefficient in air at atmospheric pressure of 23.7 mW/m K. A quartz fiber-reinforced aerogel composite from this example showed a density of 0.1310 g/cm³ and a thermal conductivity coefficient of 25.2 mW/m K.

### EXAMPLE 3

First, 3.62 g of Mondur TD-80 TDI were weighed into a polypropylene container with a screw cap. Subsequently 90.85 g of acetone were added and the mixture was stirred to obtain a homogeneous solution. Next, 4.88 g of Jeffamine® T-3000 polyamine hardener were added to this mixture and blended until a homogeneous solution was obtained. The same ratio between functional groups of hardener and of polyisocyanate as used in Example 1 was used. To this solution 0.65 g of TEA catalyst was incorporated by using a microliter syringe. After blending the solution for 1 min, the method as described in Example 1 was used for the gelation and aging steps.

Once the aging process was completed, the wet gel was loaded into a pressure vessel and was subsequently supercritically dried using the same method as described in Example 1. The resulting polyurea aerogels was slightly less flexible than the polyurea aerogel of Example 1 prepared with the same ratio between functional groups of polyisocyanate and polyamine hardener. The obtained polyurea aerogel was opaque, had a slightly yellow color due to the color of the TD-80 TDI polyisocyanate resins, and showed the following properties: density of 0.1726 g/cm³ (shrinkage factor of about 1.73), surface area of 75 m²/g, and thermal conductivity coefficient in air at atmospheric pressure of 18.5 mW/m K. A quartz fiber-reinforced aerogel composite of this example showed a density of 0.1752 g/cm³ and thermal conductivity coefficient of 19.3 mW/m K.

### EXAMPLE 4

First, 6.75 g of Mondur ML MDI was weighed into a polypropylene container with a screw cap. Subsequently 91.07 g of acetone were added and the mixture was stirred to obtain a homogeneous solution. Next, 1.52 g of Jeffamine® D-400 polyamine hardener were added to this mixture and blended until a homogeneous solution was obtained. The same ratio between functional groups of hardener and of polyisocyanate as used in Example 1 was used. To this solution 0.65 g of TEA catalyst was incorporated by using a microliter syringe. After blending the solution for 1 min, the same method as described in Example 1 was used for the gelation and aging steps.

Once the aging process was completed, the wet gel was loaded into a pressure vessel and was subsequently supercritically dried using the same method as described in Example 1. The resulting polyurea aerogels was slightly less flexible than the aerogels of Example 1 prepared with the same ratio between functional groups of polyisocyanate and polyamine hardener. The obtained polyurea aerogel was opaque, had a slight yellow color and showed the following properties: density of 0.1568 g/cm³ (shrinkage factor of about 1.57), surface area of 65 m²/g, and a thermal conductivity coefficient in air at atmospheric pressure of 21.5 mW/m K. A quartz fiber reinforced aerogel composite of this example showed a density of 0.1493 g/cm³ and thermal conductivity coefficient of 21.6 mW/m K.

### EXAMPLE 5

For the preparation of the polyurea aerogel monoliths and coupons, 6.57 g of PAPI 94 polymeric MDI was weighed into a polypropylene container with a screw cap. Subsequently 91.31 g of acetone were added and the mixture was stirred to obtain a homogeneous solution. Next, 1.46 g of Jeffamine® D-400 polyamine hardener were added to this mixture and blended until a homogeneous solution was obtained. The same ratio between functional groups of hardener and of polyisocyanate as used in Example 1 was used. To this solution 0.65 g of TEA catalyst was incorporated using a microliter syringe. After blending the solution for about 1 min, the same method as described in Example 1 was used for the gelation and aging steps.

Once the aging process was completed, the wet gel was loaded into a pressure vessel and was subsequently supercritically dried using the same method as described in Example 1. The resulting polyurea aerogels was slightly less flexible than the aerogels of Example 2 prepared with the same ratio between functional groups of polyisocyanate and polyamine hardener. The obtained polyurea aerogel was opaque, had a slightly yellow color due to the color of the PAPI 94 polyisocyanate resins, and showed the following properties: density of 0.1425 g/cm³ (shrinkage factor of about 1.43), surface area of 80 m²/g, and a thermal conductivity coefficient in air at atmospheric pressure of 25.6 mW/m K. A quartz fiber-reinforced aerogel composite using the steps of this example showed a density of 0.1441 g/cm³ and thermal conductivity coefficient of 26.7 mW/m K.

We claim:

1. A method for preparing a polyurea aerogel comprising the steps of:
mixing an isocyanate or polyisocyanate with a polyoxyalkyleneamine in a solvent, thereby forming a mixture;
allowing the mixture to form a gel; and
supercritically drying the gel.

2. The method of claim 1 further comprising the step of adding a catalyst to the mixture.

3. The method of claim 1 further comprising the step of adding an additive to the mixture.

4. The method of claim 1 further comprising the step of introducing the mixture into a fibrous structure.

5. The method of claim 1 further comprising the step of aging the gel.

6. The method of claim 1 wherein said polyoxyalkyleneamine has a molecular weight between about 500 and about 5000.

7. The method of claim 2 wherein the catalyst is tertiary amine.

8. The method of claim 3 wherein the additive comprises, an opacifier, chopped fibers, particulates or a combination thereof.

9. The method of claim 4 wherein the fibrous structure is a felt, mat, batting or a combination thereof.

10. The method of claim 5 wherein aging is carried out at elevated temperatures.

11. The method of claim 1 wherein the polyisocyanate is selected from the group consisting essentially of: aliphatic diisocyanates, cycloaliphatic diisocyanates, araliphatic diisocyanates, heterocyclic diisocyanates, aromatic diisocyanates diisocyanates, 1,6-hexamethylene diisocyanate, isophorone diisocyanate, 1,4-cyclohexane-diisocyanate, 1-methyl-2,4-cyclohexane diisocyanate, 1-methyl-2,6-cyclohexane diisocyanate, 4,4′-dicyclohexylmethane diisocyanate, 2,4′-dicyclohexylmethane diisocyanate, 2,2′-dicyclohexylmethane diisocyanate, toluene 2,4-diisocyanate (TDI), mixtures of toluene 2,4-diisocyanate and toluene 2,6-diisocyanate, 4,4′-diphenylmethane diisocyanate (MDI), 2,4′-diphenylmethane diisocyanate, 2,2′-diphenylmethane diisocyanate, mixtures of 2,4′-diphenylmethane diisocyanate and 4,4′-diphenylmethane diisocyanate, urethane-modified liquid 4,4′-diphenylmethane diisocyanates, 2,4′-di-phenylmethane diisocyanates, 4,4′-diisocyanato-diphenylethane-(1,2), 1,5-naphthylene diisocyanate, triphenylmethane 4,4′,4″-triisocyanate, polymethylene polyphenylene isocyanates (polymeric MDI), any isomeric form of the aforementioned and any mixtures of the aforementioned.

12. The method of claim 1 wherein the polyoxyalkyleneamine comprises polyoxypropylenediamines, polyoxypropylenetriamines or both.

13. The method of claim 1 wherein the ratio of the polyoxyalkyleneamine to polyisocyanate is between about 0.01:1 and about 1:1.

14. The method of claim 1 wherein the ratio of the polyoxyalkyleneamine to polyisocyanate is between about 0.05:1 and about 0.6:1

15. The method of claim 1 wherein the thermal conductivity of the aerogel is less than about 20 mW/mK.

16. The method of claim 1 wherein the density of the aerogel is between about 0.01 g/cm³ and about 0.3 g/cm³.

17. A polyurea aerogel prepared according to the method of claim 1.
